(19) United States
(12) Patent Application Publication
(10) Pub. No.: US 2014/0298287 A1
(43) Pub. Date: Oct. 2, 2014

(54) METHODS AND SYSTEMS FOR CREATING DATA APPLICATIONS

(71) Applicant: TENCENT TECHNOLOGY (SHENZHEN) COMPANY LIMITED, Shenzhen (CN)

(72) Inventor: YUSEN LAI, Shenzhen (CN)

(21) Appl. No.: 14/300,680

(22) Filed: Jun. 10, 2014

Related U.S. Application Data
(63) Continuation of application No. PCT/CN2014/071275, filed on Jan. 23, 2014.

(30) Foreign Application Priority Data
Jan. 24, 2013 (CN) 201310027188.4

(51) Int. Cl. G06F 9/44

(52) U.S. Cl. CPC G06F 8/30
USPC 717/106

(57) ABSTRACT

A method and system for creating data applications are disclosed. The method includes receiving a request for creating a first data application, the request including a first data application identification and a first data application type identification; obtaining a first data element corresponding to the first data application identification; and obtaining a second data element corresponding to the first data type application. The method further includes binding the first data element and the second data element to generate the first data application corresponding to the first data application identification.

### CROSS-REFERENCES TO RELATED APPLICATIONS

### Related Applications

This application is a continuation application of PCT Patent Application No. PCT/CN2014/071275, filed on Jan. 23, 2014, which is based upon and claims the benefit of priority from Chinese Patent Application No. 201310027188.4, filed on Jan. 24, 2013, the entire contents of which are incorporated herein by reference.

### FIELD OF THE INVENTION

The present disclosure relates to Internet technologies and, more particularly, to methods and systems for creating data applications.

### BACKGROUND

With the development of information and network technologies, huge amount of data are generated every day. The creation, transfer, and maintenance of such huge volume of data consume a lot of storage and network resources. Researchers have been motivated to simplify the processes for data creation, transfer, and maintenance, which are used by applications such as data communication applications, online computer games, or social networking websites.

For example, network servers (e.g., game servers for Diablo 3, World of Warcraft, Blade and Soul, etc.) may use different data models to present characters with different appearances, body types, movement types, etc. Many computer game applications may use various animation model files to present characters such as strong men, skinny men, horses, cattle, sheep, monsters, etc. Some game applications may have thousands, or tens of thousands of characters. Often, a game serve ma store one motion file and one skeleton file for each character. As a result, the amount of data involved in an online game may be huge, which may cause slow response time (processing time) or slow data loading (data transfer) time.

The disclosed method and system are directed to solve one or more problems set forth above and other problems.

### BRIEF SUMMARY OF THE DISCLOSURE

Embodiments consistent with the present disclosure provide a method, system, mobile device, or a server for creating data applications. Embodiments consistent with the present disclosure share data files efficiently among different types of data applications.

One aspect of the present disclosure provides a method for creating data applications. The method includes receiving a request for creating a first data application, the request including a first data application identification and a first data application type identification; obtaining a first data element corresponding to the first data application identification; and obtaining a second data element corresponding to the first data application type identification. The method further includes binding the first data element and the second data element to generate the first data application corresponding to the first data application identification.

Another aspect of the present disclosure provides a system for creating data applications. The system includes a receiving unit configured to receive a request for creating a first data application, the request including a first data application identification and a first data application type identification. The system further includes a first obtaining unit configured to obtain a first data element corresponding to the first data application identification and a second obtaining unit configured to obtain a second data element corresponding to the first data application type identification. The system further includes a binding unit configured to bind the first data element and the second data element to generate the first data application corresponding to the first data application identification.

Another aspect of the present disclosure provides a network environment for creating data applications. The network environment includes a user terminal configured to submit a request for creating a first data application, the request including a first data application identification and a first data application type identification. The network environment further includes a network server configured to receive a request for creating the first data application. The network server may further obtain a first data element corresponding to the first data application identification and obtain a second data element corresponding to the first data application type identification. The network server may also bind the first data element and the second data element to generate the first data application corresponding to the first data application identification.

Embodiments consistent with the present disclosure may receive a request for creating a first data application. The request may include a first data application identification and a first data application type identification. In some embodiments, the request for creating data application may be a request for setting up a new character (e.g., a new character in an online computer game), or other requests for creating data applications. Embodiments consistent with the present disclosure may obtain the first data element corresponding to the first data application identification and obtain the second data element corresponding to the first data application type identification. Further, embodiments consistent with the present disclosure may bind the first and the second data elements and create a first data application. Because data applications of the same data application type may share some of the same data elements, embodiments consistent with the present disclosure may use data more efficiently, and reduce the burden on the data transfer and maintenance processes.

Other aspects of the present disclosure can be understood by those skilled in the art in light of the description, the claims, and the drawings of the present disclosure.

### BRIEF DESCRIPTION OF THE DRAWINGS

To illustrate embodiments of the invention, the following are a few drawings illustrating embodiments consistent with the present disclosure.

FIG. 1-a is a flowchart of a method for creating data applications implemented by embodiments consistent with the present disclosure;

FIG. 1-b is another flowchart of a method for creating data applications implemented by embodiments consistent with the present disclosure;

FIG. 2-a is a schematic diagram of an exemplary network environment consistent with the present disclosure;

FIG. 2-b is another flowchart of a method for creating data applications implemented by embodiments consistent with the present disclosure;

FIG. 2-c is a diagram showing exemplary skeletons implemented by embodiments consistent with the present disclosure;

FIG. 2-d is a diagram showing exemplary characters implemented by embodiments consistent with the present disclosure;

FIG. 2-e is another diagram showing exemplary characters implemented by embodiments consistent with the present disclosure;

FIG. 2-f is another diagram showing exemplary characters implemented by embodiments consistent with the present disclosure;

FIG. 3-a is a diagram of an exemplary network environment consistent with the present disclosure;

FIG. 3-b is another flowchart of a method for creating data applications implemented by embodiments consistent with the present disclosure;

FIG. 4 is another exemplary system for creating data applications consistent with the present disclosure;

FIG. 5 is another diagram of an exemplary network environment consistent with the present disclosure;

FIG. 6 is a schematic diagram of an exemplary server for creating data applications consistent with the present disclosure;

FIG. 7 illustrates an exemplary communication network environment incorporating certain disclosed embodiments; and

FIG. 8 illustrates an exemplary computer game environment consistent with the disclosed embodiments.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiment, persons of ordinary skill in the art may derive other embodiments consistent with the present disclosure, all of which are within the scope of the present invention.

In the present disclosure, “first,” “second,” “third,” etc. are used to refer to certain objects without limiting the order or sequence of the objects. The specific objects and steps may be implemented in an order different from the one disclosed in each specific example. “Including” or “comprising” refer to the situations in which specific processes, methods, systems, or products are within the scope, while other processes, methods, systems, or products are not excluded from the scope. Further, a data application in the present disclosure may refer to a data file, a set of data files, or one or more files embedded with data.

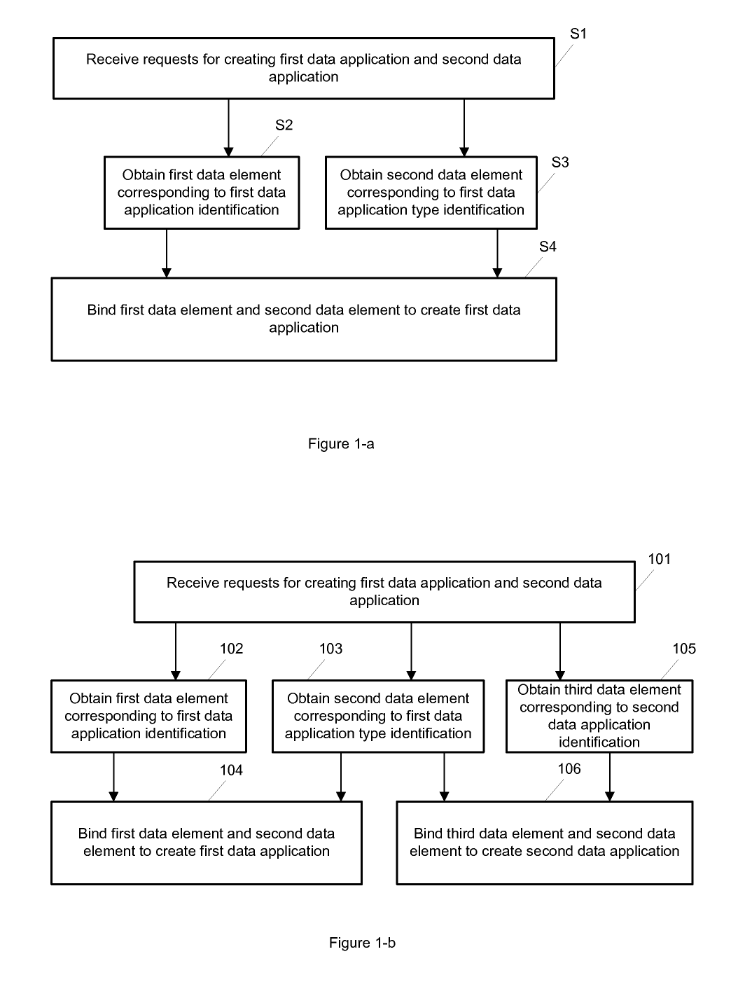

FIG. 1-a shows a flow chart of a method for creating data applications implemented by embodiments consistent with the present disclosure. The method shown in FIG. 1-a includes steps S1-S4. In step S1, a system for creating data applications may receive a request for creating a first data application. The request may include a first data application identification and a first data application type identification. In some embodiments, the request for creating data application may be a request for setting up a new character (e.g., a new character for an online computer game), or other requests for creating data applications. In step S2, the system may obtain a first data element corresponding to the first application data identification. In step S3, the system may obtain a second data element corresponding to the first data application type. Steps S2 and S3 can be implemented in different orders. In step S4, the system may bind the first and the second data elements and create a first data application.

In embodiments consistent with the present disclosure, an data application identification may be an identification of the data content (e.g., certain data packets), or an identification of a character (in a computer game), or other data identifications. A data application type identification may be a character type, a data package type, or other data types. In some embodiments, data applications may be data packets or character files or other application data items. A data element (e.g., the first and second data elements) may be any data or any data file, such as a character model file, a skeleton file, a motion file, data contents or packets, or other elements that may be used to form a data application.

For example, in computer game applications, a first request for creating data applications may be a request to create a first character. The first data application identification may be an identification of the first character. The first data application type may be the type of the first character. The first data element may be a first character model file. The second data element may be a first skeleton file and a first motion file. The first data application may be the data files related to the first character (the first character model file, first skeleton file, and first motion file).

In another example, a first request may be a request for creating a first data application. The first data application identification may be the first data packet identification. The first data application type identification may be the identification of the first data packet encapsulation. The first data element may be the content of the first data packet. The second data element may be the first data encapsulation. The first data application may be the first data packet (including the first data item and the first packet encapsulation).

In some embodiments consistent with the present disclosure, a few methods may be implemented to create scenes for character files. The methods may include receiving a request to create a first character file, wherein the request may include a first character identification and a character type identification. The methods may further include obtaining a first character model file corresponding to the first character identification and obtaining a first skeleton file and a first motion file corresponding the first character type identification. The methods may further include binding the first character model file, the first skeleton file, and the first motion file to create a file set corresponding to the first character identification. In some embodiments, the character type identification may be an identification of species. For example, the species identification may indicate that the character type may be men, women, horses, dogs, qi lin, tiger, eagle, or rocs, etc.

In embodiments consistent with the present disclosure, a character file set (e.g., the first and the second character file sets) may include one or more files. It can be understood that if a character file set includes a plurality of files, the system may store data defining the relationship among the plurality of files. If a character file set includes only one file, then the one character file may combine the data in a character model file, a skeleton file, and a motion file.

In some embodiments consistent with the present disclosure, the scenery creation data packet (which may be used to set scenes) may be generated as follows. The system may receive a request for generating a first data packet. The request may include a first data packet identification and a first data packet type identification. The system may then obtain a first data element corresponding to the first data packet identification and a second data element corresponding to the first data packet type identification. The system may bind the first data element and the first packet data element to generate the first data packet. It can be understood that one or more scenes may be generated using the same or similar methods.

Embodiments consistent with the present disclosure may receive a request for creating a first data application. The request may include a first data application identification and a first data application type identification. In some embodiments, the request for creating data application may be a request for setting up a new character (e.g., a new character in an online computer game), or other requests for creating data applications. Embodiments consistent with the present disclosure may obtain the first data element corresponding to the first data application identification and obtain the second data element corresponding to the first data application type identification. Further, embodiments consistent with the present disclosure may bind the first and the second data elements and create a first data application. Because data applications of the same data application type may share some of the same data elements, embodiments consistent with the present disclosure may use data more efficiently, and reduce the burden on the data transfer and maintenance processes.

Yet in another embodiment consistent with the present disclosure, the system for creating data applications may receive one request for creating a first data application and a second request for creating a second data application. The first request may include a first data application identification and a first data application type identification. The second request may include a second data application identification and a second data application type identification. The system may obtain the first data element corresponding to the first data application identification and obtain the second data element corresponding to the first data application type. Further, the system may bind the first and the second data elements and create the first data application. The system may obtain the third data element corresponding to the second data application identification and obtain the fourth data element corresponding to the second data application type identification. Further, the system may bind the third and fourth data elements and create the second data application.

FIG. 1-b is another flow chart for creating data applications consistent with the present disclosure. The method shown in FIG. 1-b includes steps 101-106. In step 101, the system for creating data applications may receive one request for creating a first data application and a second request for creating a second data application. The first request may include a first data application identification and a first data application type identification. The second request may include a second data application identification and the first data application type identification. The requests may be submitted from the same or different user terminals. The requests for creating data applications may be a request to create a character file, a data packet, or other data applications.

In step 102, the system may obtain the first data element corresponding to the first data application identification. In step 103, the system may obtain the second data element corresponding to the first data application type. Steps 102 and 103 may be executed in different orders. In step 104, the system may bind the first and the second data elements and create the first data application. In step 105, the system may obtain the third data element corresponding to the second data application identification. In Step 106, the system may bind the third and the second data elements and create the second data application.

In embodiments consistent with the present disclosure, an data application identification (e.g., the first data application identification and the second application data identification) may be an identification of data content, or an identification of a character, or other data identifications. A data application type identification (e.g., the first data application type identification) may be a character type, a package type, or other data types. In some embodiments, data applications may be data packets, character files, or other application data items. A data element (e.g., the first, second, and third data elements) may be any data or data file such as a character model file, a skeleton file, a motion file, data contents or packets, or other elements that may be used to form an application data item.

For example, the first request for creating data applications may be a request to create a first character. The first data application identification may be an identification of the first character. The first data type may be the type of the first character. The first data element may be a first character model file. The second data element may be a first skeleton file and a first motion file. The first data application may be the data files (the first character model file, the first skeleton file, the first motion file) related to the first character. The second request for creating data applications may be a request to create a second character of the same character type. The third data element may be a second character model file. The second data application may be the data files (the second character model file, the first skeleton file, the first motion file) related to the second character.

In some embodiments consistent with the present disclosure, the first request for creating data applications may be a request to create a first data packet. The request may include a first data packet identification and a first data packet type identification. The system may then obtain a first data element corresponding to the first data packet identification and a second data element corresponding to the first data packet type identification. The system may bind the first data element and the second data element to generate the first data packet. It can be understood that one or more scenes may be generated using this method or similar methods. The second request for creating data applications may be a request to create a second data packet. The second request may include a second data application identification and a first packet type identification. They system may obtain the third data element corresponding to the second data packet identification. The system may bind the third data element and second data element to generate the second data packet.

In embodiments consistent with the present disclosure, the system for creating data applications may generate animation characters and scenes with animations and special effects. The system may receive a request for a first character and a request for a second character. The first request may include a first character identification and a first character type identification. The second request may include a second character identification and the first character type identification. The system may obtain the first data element, which may be a first character model file. The system may obtain the second data element, which may be a first skeleton file and a first motion file. The system may obtain the third data element, which may be a second character model file. The first character file set may include the first character model file, the first skeleton file, and the first motion file. The second character file set may include the second character model file, the first skeleton file, and the first motion file. In some embodiments, the character type identification may be an identification of species. The species identification may indicate that the character type may be men, women, horses, dogs, qi lin, tiger, eagle, or rocs, etc.

In embodiments consistent with the present disclosure, a character file set (e.g., the first and the second character file sets) may include one or more files. It can be understood that if a character file set includes a plurality of files, the system may store data defining the relationship among the plurality of files. If a character file set includes only one file, then the one character file may combine the data in a character model file, a skeleton file, and a motion file.

In some embodiments consistent with the present disclosure, the first request for creating data applications may be a request to create a first data packet. The request may include a first data packet identification and a first data packet type identification. The system may then obtain a first data element corresponding to the first data packet identification and a second data element corresponding to the first data packet type identification. The system may bind the first data element and the second data element to generate the first data packet. It can be understood that one or more scenes may be generated using this method or similar methods. The second request for creating data applications may be a request to create a second data packet. The second request may include a second data application identification and a first data packet type identification. They system may obtain the third data element corresponding to the second data packet identification. The system may bind the third data element and second data element to generate the second data packet.

Embodiments consistent with the present disclosure may receive a request for creating a first data application. The request may include a first data application identification and a first data application type identification. In some embodiments, the request for creating data application may be a request for setting up a new character (e.g., a new character in an online computer game), or other requests for creating data applications. Embodiments consistent with the present disclosure may obtain the first data element corresponding to the first data application identification and obtain the second data element corresponding to the first data application type identification. Further, embodiments consistent with the present disclosure may bind the first and the second data elements and create a first data application. Because data applications of the same data application type may share some of the same data elements, embodiments consistent with the present disclosure may use data more efficiently, and reduce the burden on the data transfer and maintenance processes.

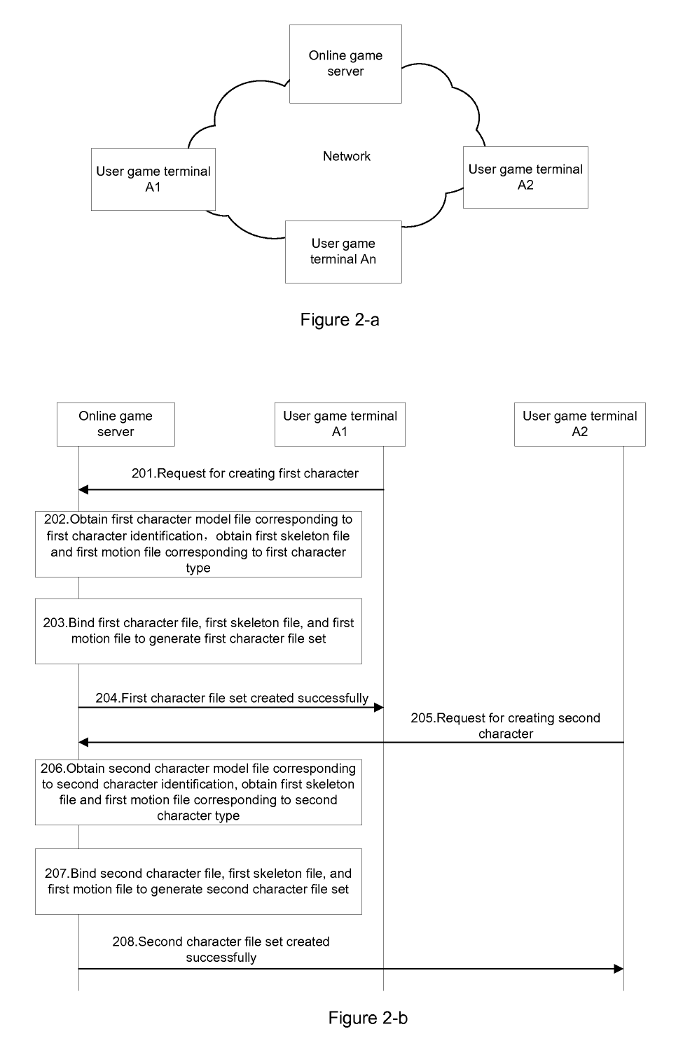

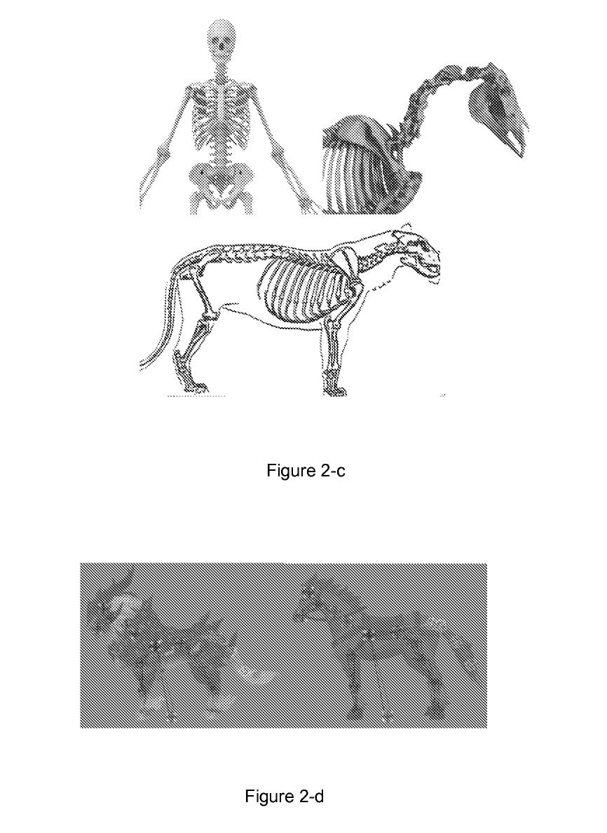

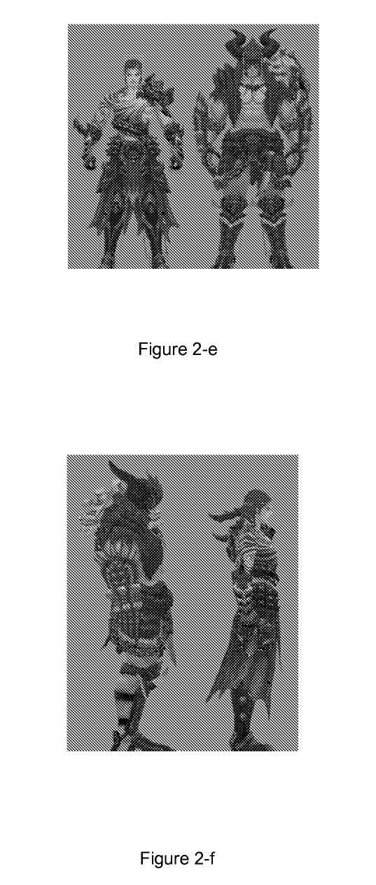

FIG. 2-a shows an exemplary network environment consistent with the present disclosure. The network environment shown in FIG. 2-a includes a number of user game terminals and online game servers. The environment shown in FIG. 2-a may be used to host various computer games such as Diablo 3, the World of Warcraft, Blade and Soul, etc.

FIG. 2-b shows another flow chart of a method for creating data applications consistent with the present disclosure. The method shown in FIG. 2-b includes steps 201-208. In step 201, the user game terminal A1 may send a first request for generating a first character to the online game server. The first request for character generation may include a first character identification (Ferghana horse) and a first character type identification (horse). The first request may also include a user name K1. In step 202, after receiving the request from the user game terminal A1, the online game server may obtain a first character file corresponding to the first character identification (Ferghana horse). The system may also obtain a first skeleton file and a first motion file corresponding to the character type identification (horse). In step 203, the online game server may combine the first character file, the first skeleton file, and the first motion file into a first character file set. One file set may include one or more files. In step 204, the online game server may store the first character file set and send the user game terminal A1 a message indicating the data creation is successful. The user may then log in with user name K1 and use the first character file set (Ferghana horse file set).

In step 205, the user game terminal A2 may send a second request for generating a second character to the online game server. The second request for character generation may include a second character identification (European horse) and a first character type identification (horse). The second request may also include a user name K2. In step 206, after receiving the request from the user game terminal A2, the online game server may obtain a second character file corresponding to the second character identification (European horse). The system may also obtain a first skeleton file and a first motion file corresponding to the character type (horse). In step 207, the online game server may combine the second character file, the first skeleton file, and the first motion file into a second character file set (European horse file set). One file set may include one or more files. In step 204, the online game server may store the second character file set and send the user game terminal A2 a message indicating the data creation is successful. The user may then log in with user name K2 and use the second character file set.

For ease of understanding, FIGS. 2c-2f provide additional examples of characters generated by systems consistent with the present disclosure. FIG. 2-c illustrates exemplary skeletons consistent with the present disclosure. FIG. 2-d shows two character illustrations using a common skeleton file and a common motion file consistent with the present disclosure. FIG. 2-e shows two other character illustrations using a common skeleton file and a common motion file consistent with the present disclosure. FIG. 2-f shows another two character illustrations using a common skeleton file and a common motion file consistent with the present disclosure. The pair of characters shown in FIGS. 2-d, 2-e, and 2-f share a common skeleton file and a common motion file.

Embodiments consistent with the present disclosure may use a common skeleton file and motion file for multiple characters of one character type. Because data applications of the same data application type may share some of the same data elements, embodiments consistent with the present disclosure may use the data efficiently, and reduce the burden on the data transfer and maintenance processes.

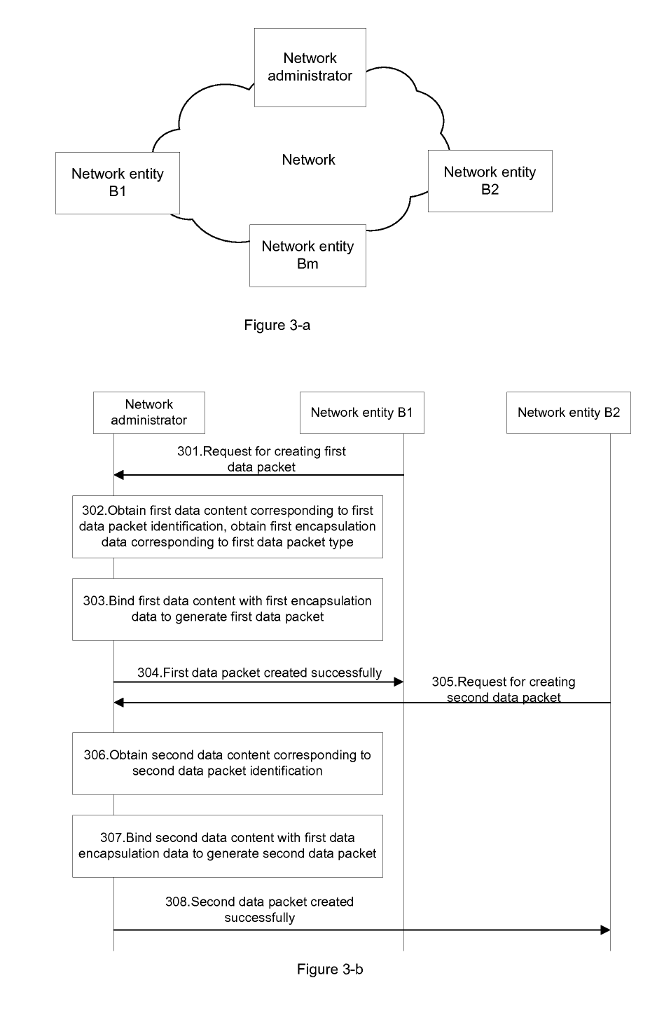

FIG. 3-a shows an exemplary network environment consistent with the present disclosure. The network environment shown in FIG. 3-a includes a number of user terminals and servers. FIG. 3-b shows another flow chart of a method for creating data applications consistent with the present disclosure. The method shown in FIG. 3-b includes steps 301-308.

In step 301, the user terminal B1 may send a first request for generating a first data packet to the server. The first request for data packet generation may include a first data packet identification and a first data packet type identification. In step 302, after receiving the request from the user terminal B1, the server may obtain a first data element corresponding to the first data packet identification (data content). The server may also obtain a second data element (encapsulation data) corresponding to the first data packet type (e.g., an encapsulation header of protocol P1). In step 303, the server may combine the first data element (data content), and the second data element (encapsulation data) corresponding to the first data packet type (e.g., an encapsulation header of protocol P1) into a first data packet file set. One file set may include one or more files. In step 304, the online game server may store the first data packet file set and send the user terminal B1 a message indicating the data creation is successful.

In step 305, the user terminal B2 may send a second request for generating a second data packet to the server. The second request for data packet generation may include a second data packet identification and the first data packet type identification. In step 306, after receiving the request from the user terminal A2, the server may obtain a third data element corresponding to the second data packet identification. In step 307, the server may combine the third data element and the second data element into a second data packet file set. One file set may include one or more files. In step 308, the online game server may store the second data packet file set and send the user game terminal B2 a message indicating the data creation is successful.

Embodiments consistent with the present disclosure may use a common data element (encapsulation data) for multiple data packets of the same data packet type. Because data applications of the same data application type may share some of the same data elements, embodiments consistent with the present disclosure may use the data efficiently, and reduce the burden on the data transfer and maintenance processes.

Other than the exemplary embodiments discussed above, other embodiments of the present disclosure will be apparent to those skilled in the art from consideration of the specification and the descriptions of the invention disclosed herein. To further illustrate the implementations of the various embodiment of the present disclosure, a few exemplary systems consistent with the present disclosure are further discussed below.

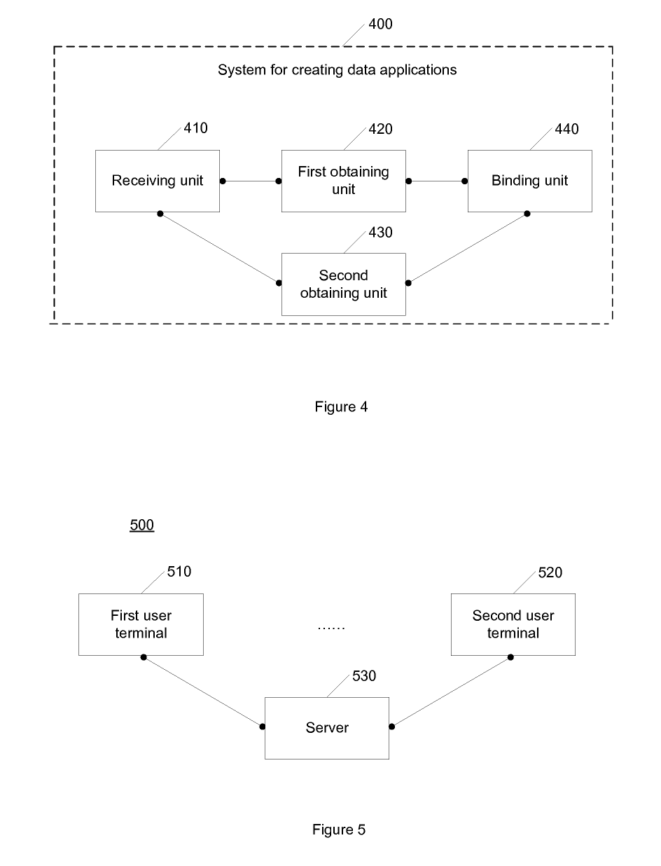

FIG. 4 shows an exemplary system 400 for creating data applications consistent with the present disclosure. The system 400 may include a receiving unit 410, a first obtaining unit 420, a second obtaining unit 430, and a binding unit 440. The receiving unit 410 may receive requests to create data applications, such as a request for creating a first data application. The request may include a first data application identification and a first data application type identification. The first obtaining unit 420 may obtain a first data element corresponding to the first data application identification. The second obtaining unit 430 may obtain the second data element corresponding to the first data application type identification. The binding unit 440 may bind the first data element and the second data element into a first data application.

In some embodiments, the receiving unit 410 may receive a second request for a second data application. The request may include a second data application identification and the first data application type identification. The first obtaining unit 420 may obtain a third data element corresponding to the second data application identification. The binding unit 440 may bind the third data element and the second data element into a second data application.

In embodiments consistent with the present disclosure, the system for creating data applications may generate animation characters, and scenes with animations and special effects. The receiving unit 410 may receive a request for a first character and a request for a second character. The first request may include a first character identification and a first character type identification. The second request may include a second character identification and the first character type identification. The first obtaining unit 420 may obtain the first data element, which may be a first character model file. The second obtaining unit 430 may obtain the second data element, which may be a first skeleton file and a first motion file. The first obtaining unit 420 may also obtain the third data element, which may be a second character model file. The binding unit 440 may create a first character file set by binding the first character model file, the first skeleton file, and the first motion file. The binding unit 440 may create a second character file set by binding the second character model file, the first skeleton file, and the first motion file. In some embodiments, the character type identification may be an identification of species. In embodiments consistent with the present disclosure, a character file set (e.g., the first and the second character file sets) may include one or more files.

In some embodiments consistent with the present disclosure, the receiving unit 410 may receive a first request for creating data applications, which may be a request to create a first data packet. The request may include a first data packet identification and a first data packet type identification. The receiving unit 410 may receive a second request for creating data applications, which may be a request to create a second data packet. The second request may include a second data packet identification and a first data packet type identification. The first obtaining unit 420 may then obtain a first data element corresponding to the first data packet identification. The second obtaining unit 430 may obtain a second data element corresponding to the first packet data type identification. The binding unit 440 may bind the first data element and the second data element to generate the first data packet. It can be understood that one or more scenes may be generated using the same or similar methods. The first obtaining unit 420 may also obtain the third data element corresponding to the second data application. The binding unit 440 may bind the third data element and second data element to generate the second data packet.

It can be understood that the functions of the components in system 400 may be implemented as described above or in similar manners consistent with the spirit of the present disclosure. Embodiments consistent with the present disclosure, such as system 400, may receive a request for creating a first data application. The request may include a first data application identification and a first data application type identification. In some embodiments, the request for creating data application may be a request for setting up a new character (e.g., for an online computer game), or other requests for creating data applications.

Embodiments consistent with the present disclosure may obtain the first data element corresponding to the first data application identification and obtain the second data element corresponding to the first data application type identification. Further, embodiments consistent with the present disclosure may bind the first and the second data elements and create a first data application. Because data applications of the same data application type may share some of the same data elements, embodiments consistent with the present disclosure may use the data efficiently, and reduce the burden on the data transfer and maintenance processes.

In particular, when creating characters of the same character type, because the characters of the same character type may share some of the same data elements, such as the same skeleton files and motion files, embodiments consistent with the present disclosure may use these common files more efficiently, and reduce the burden on the data transfer and maintenance processes. When creating scenes of the same scene type, because the data packets of the same data packet type may share some of the same data elements, such as the same encapsulation data, embodiments consistent with the present disclosure may use these common files more efficiently, and reduce the burden on the data transfer and maintenance processes.

FIG. 5 shows a network environment consistent with the present disclosure. The system shown in FIG. 5 includes two user terminals 510 and 520 and a server 530. The server 530 may receive a first request for creating a first data application from the first user terminal 510. The server 530 may receive a second request for creating a second data application from the second user terminal 520.

In some embodiments consistent with the present disclosure, the first request for creating data applications may be a request to create a first data application. The request may include a first data packet identification and a first data packet type identification. The second request for creating data applications may be a request to create a second data application. The second request may include a second data packet identification and a first data packet type identification. The system may then obtain a first data element corresponding to the first data packet identification and a second data element corresponding to the first data packet type. The system may bind the first data element and the second data element to generate the first data packet. It can be understood that one or more scenes (e.g., in computer games) may be generated using the same or similar methods. After server 530 receives the second request for creating the second data application, the system may obtain the third data element corresponding to the second data packet identification. The system may bind the third data element and second data element to generate the second data packet.

In some embodiment, the first data application identification may be an identification of the first character. The first data type may be the type of the first character. The first data element may be a first character model file. The second data element may be a first skeleton file and a first motion file. The first data application may be the data files (the first character model file, the first skeleton file, the first motion file) related to the first character. The second request for creating data applications may be a request to create a second character of the same character type. The third data element may be a second character model file. The second data application may be the data files (the second character model file, the first skeleton file, the first motion file) related to the second character.

In embodiments consistent with the present disclosure, the system for creating data applications may generate animation characters, and scenes with animations and special effects. The system may receive a request for a first character and a request for a second character. The first request may include a first character identification and a first character type identification. The second request may include a second character identification and the first character type identification. The system may obtain the first data element, which may be a first character model file. The system may obtain the second data element, which may be a first skeleton file and a first motion file. The system may obtain the third data element, which may be a second character model file. The system may bind the first character model file, the first skeleton file, and the first motion file to generate the first character file set. The system may bind the second character model file, the first skeleton file, and the first motion file to generate the second character file set. In some embodiments, the character type identification may be an identification of species. The species identification may indicate that the character type may be men, women, horses, dogs, qi lin, tiger, eagle, or rocs, etc.

In embodiments consistent with the present disclosure, a character file set (e.g., the first and the second character file sets) may include one or more files. It can be understood that if a character file set includes a plurality of files, the system may store data defining the relationship among the plurality of files. If a character file set includes only one file, then the one character file may combine the data in a character model file, a skeleton file, and a motion file.

In some embodiments consistent with the present disclosure, the first request for creating data applications may be a request to create a first data packet. The request may include a first data packet identification and a first data packet type identification. The system may then obtain a first data element corresponding to the first data packet identification and a second data element corresponding to the first data packet type identification. The system may bind the first data element and the second data element to generate the first data packet. It can be understood that one or more scenes may be generated using this method or similar methods. The second request for creating data applications may be a request to create a second data packet. The second request may include a second data application identification and a first packet type identification. They system may obtain the third data element corresponding to the second data packet identification. The system may bind the third data element and second data element to generate the second data packet.

It can be understood that the functions of the components in system 500 may be implemented as described above or in similar manners consistent with the spirit of the present disclosure. Embodiments consistent with the present disclosure, such as server 530, may receive a request for creating a first data application. The request may include a first data application identification and a first data application type identification. In some embodiments, the request for creating data application may be a request for setting up a new character (e.g., for an online computer game), or other requests for creating data applications.

Embodiments consistent with the present disclosure may obtain the first data element corresponding to the first data application identification and obtain the second data element corresponding to the first data application type identification. Further, embodiments consistent with the present disclosure may bind the first and the second data elements and create the first data application. Because data applications of the same data type may share some of the same data elements, embodiments consistent with the present disclosure may use the data efficiently, and reduce the burden on the data transfer and maintenance processes.

In particular, when creating characters of the same character type, because the characters of the same character type may share some of the same data elements, such as the same skeleton files and motion files, embodiments consistent with the present disclosure may use these common files efficiently, and reduce the burden on the data transfer and maintenance processes. When creating scenes of the same scene type, because the data packets of the same data packet type may share some of the same data elements, such as the same encapsulation data, embodiments consistent with the present disclosure may use these common files efficiently, and reduce the burden on the data transfer and maintenance processes.

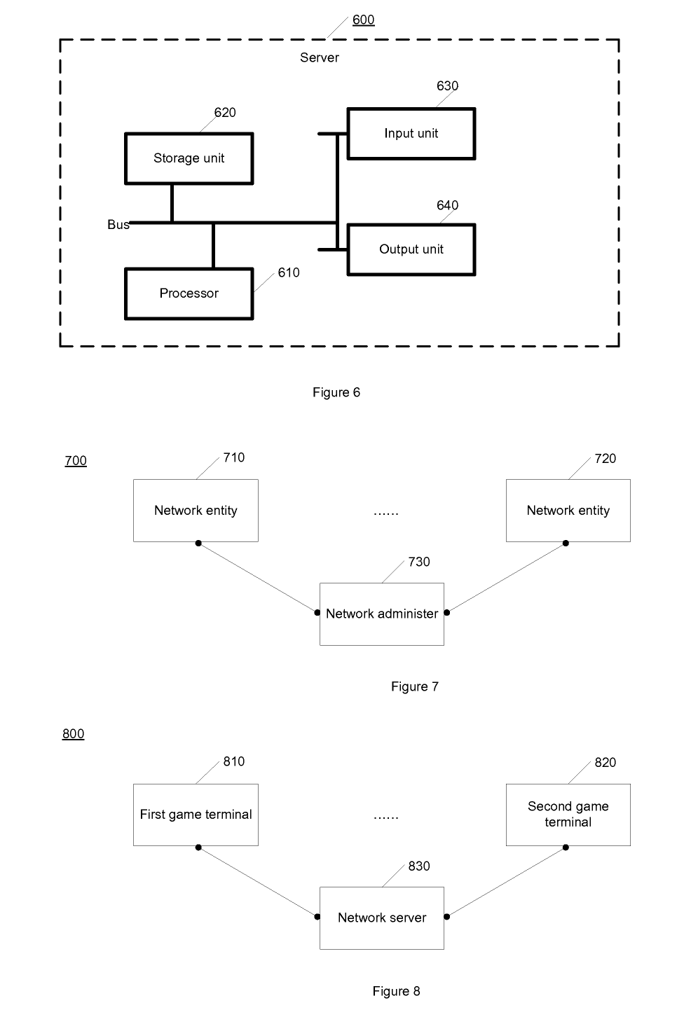

FIG. 6 shows an exemplary server 600 consistent with the present disclosure. The server 600 shown in FIG. 6 includes a processor 610, a storage unit 620, an input unit 630, and an output unit 640. The server 600 may include one or more processors 610. In embodiments consistent with the present disclosure, the processor 610, the storage unit 620, the input unit 630, and the output unit 640 may be connected by a bus or other connections. FIG. 6 shows the configuration with these components connected by a bus. The processor 610 may execute the following steps.

The processor 610 may receive a first request for creating data applications, which may be a request to create a first data application. The request may include a first data packet identification and a first data packet type identification. The processor 610 may receive a second request for creating data applications, which may be a request to create a second data application. The second request may include a second data packet identification and a first data packet type identification. The system may then obtain a first data element corresponding to the first data packet identification and a second data element corresponding to the first data packet type identification. The system may bind the first data element and the second data element to generate the first data packet. It can be understood that one or more scenes may be generated using the same or similar methods. After processor 610 receives the second request for creating the second data application, the system may obtain the third data element corresponding to the second data packet identification. The processor 610 may bind the third data element and second data element to generate the second data packet.

In some embodiment, the first data application identification may be an identification of the first character. The first data type may be the type of the first character. The first data element may be a first character model file. The second data element may be a first skeleton file and a first motion file. The first data application may be the data files (the first character model file, the first skeleton file, the first motion file) related to the first character. The second request for creating data applications may be a request to create a second character of the same character type. The third data element may be a second character model file. The second data application may be the data files (the second character model file, the first skeleton file, the first motion file) related to the second character.

In embodiments consistent with the present disclosure, the system for creating data applications may generate animation characters, and scenes with animations and special effects. The processor 610 may receive a request for a first character and a request for a second character. The first request may include a first character identification and a first character type identification. The second request may include a second character identification and the first character type identification. The processor 610 may obtain the first data element, which may be a first character model file. The processor 610 may obtain the second data element, which may be a first skeleton file and a first motion file. The processor 610 may obtain the third data element, which may be a second character model file. The first character file set may include the first character model file, the first skeleton file, and the first motion file. The second character file set may include the second character model file, the first skeleton file, and the first motion file. In some embodiments, the character type identification may be an identification of species. The species identification may indicate that the character type may be men, women, horses, dogs, qi lin, tiger, eagle, or rocs, etc.

In embodiments consistent with the present disclosure, a character file set (e.g., the first and the second character file sets) may include one or more files. It can be understood that if a character file set includes a plurality of files, the system may store data defining the relationship among the plurality of files. If a character file set includes only one file, then the one character file may combine a character model file, a first skeleton file, and a first motion file.

In some embodiments consistent with the present disclosure, the first request for creating data applications may be a request to create a first data packet. The request may include a first data packet identification and a first data packet type identification. The second request for creating data applications may be a request to create a second data packet. The second request may include a second data packet identification and a first data packet type identification. The processor 610 may then obtain a first data element corresponding to the first data packet identification and a second data element corresponding to the first data packet type identification. The processor 610 may bind the first data element and the second data element to generate the first data packet. It can be understood that one or more scenes may be generated using the same or similar methods. The system may obtain the third data element corresponding to the second data packet identification. The processor 610 may bind the third data element and second data element to generate the second data packet.

Embodiments consistent with the present disclosure, for example, server 610, may receive a request for creating a first data application. The request may include a first data application identification and a first data application type identification. In some embodiments, the request for creating data application may be a request for setting up a new character (e.g., for an online computer game), or other requests for creating data applications.

Embodiments consistent with the present disclosure may obtain the first data element corresponding to the first data application identification and obtain the second data element corresponding to the first data application type identification. Further, embodiments consistent with the present disclosure may bind the first and the second data elements and create a first data application. Because data applications of the same data application type may share some of the same data elements, embodiments consistent with the present disclosure may use the data efficiently, and reduce the burden on the data transfer and maintenance processes.

In particular, when creating multiple characters of the same character type, because the characters of the same character type may share some of the same data elements, such as the same skeleton files and motion files, processor 610 may use these common files efficiently, and reduce the burden on the data transfer and maintenance processes. When creating scenes of the same scene type, because the data packets of the same data packet type may share some of the same data elements, such as the same encapsulation data, processor 610 may use these common files efficiently, and reduce the burden on the data transfer and maintenance processes.

FIG. 7 shows another network environment 700 consistent with the present disclosure. The system shown in FIG. 7 includes two network entities 710 and 720 and a network administrator 730. The network administrator 730 may receive a first request for creating a first data application from the network entity 710. The network administrator 730 may receive a second request for creating a second data application from the network entity 720.

The network administrator 730 may receive a first request for creating data applications, which may be a request to create a first data application. The request may include a first data packet identification and a first data packet identification. The network administrator 730 may receive a second request for creating data applications, which may be a request to create a second data application. The second request may include a second data packet identification and a first data packet identification. The network administrator 730 may then obtain a first data element corresponding to the first data packet identification and a second data element corresponding to the first data packet type identification. The system may bind the first data element and the second data element to generate the first data packet. It can be understood that one or more scenes may be generated using the same or similar methods. After the network administrator 730 receives the second request for creating the second data packet, the system may obtain the third data element corresponding to the second data packet type identification. The system may bind the third data element and second data element to generate the second data packet.

It can be understood that the functions of the components in system 700 may be implemented as described above or in similar manners consistent with the spirit of the present disclosure. Further, when creating scenes of the same scene type, because the data packets of the same data packet type may share some of the same data elements, such as the same encapsulation data, embodiments consistent with the present disclosure may use these common files efficiently, and reduce the burden on the data transfer and maintenance processes.

FIG. 8 shows another network environment 800 consistent with the present disclosure. The system shown in FIG. 8 includes two game terminals 810 and 820 and a network server 830. The network server 830 may receive a first request for creating a first data application from the first game terminal 810. The network server 830 may receive a second request for creating a second data application from the second game terminal 820.

In embodiments consistent with the present disclosure, the system for creating data applications may generate animation characters and scenes with animations and special effects. The network server 830 may receive a request for a first character and a request for a second character. The first request may include a first character identification and a first character type identification. The second request may include a second character identification and the first character type identification. The network server 830 may obtain the first data element, which may be a first character model file. The network server 830 may obtain the second data element, which may be a first skeleton file and a first motion file. The network server 830 may obtain the third data element, which may be a second character model file. The first character file set may include the first character model file, the first skeleton file, and the first motion file. The second character file set may include the second character model file, the first skeleton file, and the first motion file. In some embodiments, the character type identification may be an identification of species. The species identification may indicate that the character type may be men, women, horses, dogs, qi lin, tiger, eagle, or rocs, etc.

In embodiments consistent with the present disclosure, a character file set (e.g., the first and the second character file sets) may include one or more files. It can be understood that if a character file set includes a plurality of files, the system may store data defining the relationship among the plurality of files. If a character file set includes only one file, then the one character file may combine the data in a character model file, a skeleton file, and a motion file.

It can be understood that the functions of the components in system 800 may be implemented as described above or in similar manners consistent with the spirit of the present disclosure. In particular, when creating characters of the same character type, because the characters of the same character type may share some of the same data elements, such as the same skeleton files and motion files, system 800 may use these common files efficiently, and reduce the burden on the data transfer and maintenance processes.

Consistent with embodiments of the present disclosure, one or more non-transitory storage medium storing a computer program are provided to implement the system and method for creating data applications. A computer may read the computer program from the storage medium and execute the program to perform the methods consistent with embodiments of the present disclosure. Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

In summary, embodiments consistent with the present disclosure may receive a request for creating a first data application. The request may include a first data application identification and a first data application type identification. In some embodiments, the request for creating data application may be a request for setting up a new character (e.g., a new character in an online computer game), or other requests for creating data applications. Embodiments consistent with the present disclosure may obtain the first data element corresponding to the first data application identification and obtain the second data element corresponding to the first data application type identification. Further, embodiments consistent with the present disclosure may bind the first and the second data elements and create a first data application. Because data applications of the same data application type may share some of the same data elements, embodiments consistent with the present disclosure may use data efficiently, and reduce the burden on the data transfer and maintenance processes. In particular, in computer game applications, when creating characters of the same character type, because the characters of the same character type may share some of the same data elements, such as the same skeleton files and motion files, embodiments consistent with the present disclosure may use these common files efficiently, and reduce the burden on the data transfer and maintenance processes.

It is understood that the embodiments disclosed above are exemplary. For example, the components of the various computer environments are descriptive. Embodiments of the present disclosure may implement the system for creating data applications in any manner that is within the spirit of the present disclosure. In addition, the couplings or connections among the system components may be electrical or otherwise. The functional components may be physically separate or together. The functional components shown in the Figures may be one or more physical modules, and/or located in one or more devices. Embodiments consistent with the present disclosure may implement some or all of the disclosed components. Furthermore, the functional components discussed above may be implemented in one or more processing units. The processing units may be implemented using hardware and/or software components.

Software embodiments of the present disclosure may be sold as independent products. The software may be stored in computer readable medium. Consistent with embodiments of the present disclosure, one or more non-transitory storage medium storing a computer program are provided to implement the system and method for creating data applications. The one or more non-transitory storage medium may be installed in a computer or provided separately from a computer. A computer may read the computer program from the storage medium and execute the program to perform the methods consistent with embodiments of the present disclosure. The storage medium may be a magnetic storage medium, such as hard disk, floppy disk, or other magnetic disks, a tape, or a cassette tape. The storage medium may also be an optical storage medium, such as optical disk (for example, CD or DVD). The storage medium may further be semiconductor storage medium, such as DRAM, SRAM, EPROM, EEPROM, flash memory, or memory stick.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and systems, various systems for creating data applications may be implemented. For example, an embodiment consistent with the present disclosure may share various animation data files, such as skeleton files and motion files, among multiple characters of the same type of characters. Another embodiment consistent with the present disclosure may share skeleton files and motions files among certain type of character body parts (e.g., foot, hand, claws, etc.). Yet another embodiment consistent with the present disclosure may share other structure files and movement files among certain types of objects (e.g., vehicle, vessel, etc.). By sharing certain common data files among different data applications, the system for creating data applications provides users with an enriched user experience while using data, processing resources, and network resources efficiently.

What is claimed is:

1. A method for creating data applications, comprising:
receiving a request for creating a first data application, the request including a first data application identification and a first data application type identification;
obtaining a first data element corresponding to the first data application identification;
obtaining a second data element corresponding to the first data application type identification; and
binding the first data element and the second data element to generate the first data application corresponding to the first data application identification.

2. The method according to claim 1, further comprising:
receiving a request for creating a second data application, the request including a second data application identification and a first data application type identification;
obtaining a third data element corresponding to the second data application identification; and
binding the third data element and the second data element to generate the second data application corresponding to the second data application identification.

3. The method according to claim 2, wherein the request for creating the first data application is a request for creating a first character file set; the first data application identification is a first character; the first data application type identification is a first character type; the first data element is a first character model file; the second data element is a first skeleton file and a first motion file; and the first data application is the first character file set.

4. The method according to claim 2, wherein the request for creating the first data application is a request for creating a first character file set; the first data application identification is a first character; the first data application type identification is a first character type; and the first character type is a type of species.

5. The method according to claim 1, wherein the request for creating the first data application is a request for creating a first data packet; the first data application identification is a first data packet; the first data application type identification is a first data packet type; the first data element is a first data content; the second data element is a first encapsulation data; and the first data application is the first data packet.

6. A system for creating data applications, comprising:
a receiving unit configured to receive a request for creating a first data application, the request including a first data application identification and a first data application type identification;
a first obtaining unit configured to obtain a first data element corresponding to the first data application identification;
a second obtaining unit configured to obtain a second data element corresponding to the first data application type identification; and
a binding unit configured to bind the first data element and the second data element to generate the first data application corresponding to the first data application identification.

7. The system according to claim 6, wherein the receiving unit is further configured to receive a request for creating a second data application, the request including a second data application identification and a first data application type identification.

8. The system according to claim 7, wherein the first obtaining unit is further configured to obtain a third data element corresponding to the second data application identification.

9. The system according to claim 8, wherein the binding unit is further configured to bind the third data element and the second data element to generate the second data application corresponding to the second data application identification.

10. The system according to claim 6, wherein the request for creating the first data application is a request for creating a first character file set.

11. The system according to claim 10, wherein the first data application identification is a first character and the first data application type identification is a first character type.

12. The system according to claim 11, wherein the first data element is a first character model file; the second data element is a first skeleton file and a first motion file; and the first data application is the first character file set.

13. The system according to claim 7, wherein the request for creating the first data application is a request for creating a first character file set; the first data application identification is a first character; the first data application type identification is a first character type; and the first character type is a type of species.

14. The system according to claim 6, wherein the request for creating the first data application is a request for creating a first data packet; the first data application identification is a first data packet; the first data application type identification is a data packet type; the first data element is a first data packet content; the second data element is a first encapsulation data; and
the first data application is the first data packet.

15. A network environment for creating data applications, comprising:
a user terminal configured to submit a request for creating a first data application, the request including a first data application identification and a first data application type identification;
a network server configured to receive a request for creating the first data application; to obtain a first data element corresponding to the first data application identification; to obtain a second data element corresponding to the first data application type identification; and to bind the first data element and the second data element to generate the first data application corresponding to the first data application identification.

16. The network environment according to claim 15, wherein the network server is further configured to receive a request for creating a second data application, the request including a second data application identification and a first data application type identification; to obtain a third data element corresponding to the second data application identification; and to bind the third data element and the second data element to generate the second data application corresponding to the second data application identification.

17. The network environment according to claim 16, wherein the request for creating the first data application is a request for creating a first character file set; the first data application identification is a first character; the first data application type identification is a first character type; the first data element is a first character model file; the second data element is a first skeleton file and a first motion file; the first data application is the first character file set; and the first character type is a species identification.

18. The network environment according to claim 15, wherein the request for creating the first data application is a request for creating a first data packet; the first data application identification is a first data packet; the first data application type identification is a first data packet type; the first data element is a first data content; the second data element is a first encapsulation data; and the first data application is the first data packet.
